(19) United States
(12) Patent Application Publication
(10) Pub. No.: US 2018/0231145 A1
(43) Pub. Date: Aug. 16, 2018

(54) CLAMP-ON DIRECTIONAL ANCHOR

(71) Applicant: WEIR CANADA, INC., Mississauga (CA)

(72) Inventor: Richard HAIGHT, Mississauga (CA)

(21) Appl. No.: 15/896,304

(22) Filed: Feb. 14, 2018

Related U.S. Application Data
(60) Provisional application No. 62/458,794, filed on Feb. 14, 2017.

(51) Int. Cl. F16L 3/10

(52) U.S. Cl. CPC F16L 3/1091; F16L 3/1066

(57) ABSTRACT

A system for anchoring a pipe relative to a ground-mounted support comprises: a first clamp for engagement with the pipe at a first axial displacement from the support; and a second clamp for engagement with the pipe at a second axial displacement from the support, the second axial displacement having a direction opposite to the first axial displacement; each of the first clamp and the second clamp including: a primary member and a secondary member, removably fastenable together to encircle and apply a clamping force to the pipe; at least one of the primary member and the secondary member having a radially extending wall configured to engage the support for inhibiting axial movement of the pipe relative to the support.

### CROSS-REFERENCE TO RELATED APPLICATIONS

This application claims priority from U.S. provisional patent application No. 62/458794, filed Feb. 14, 2017, the contents of which is incorporated herein by reference.

### FIELD

The specification relates generally to pipe fittings, and specifically to a clamp-on anchor for a pipe.

### BACKGROUND

Various types of piping are known for high-wear applications, such as those encountered in slurry service for mining and oilsands operations. Polymer-lined pipes, for example, may be employed in such situations. Polymer-lined pipes include an outer metal (e.g. steel) wall and an inner polymer lining, typically rubber or urethane in contact with the fluid and debris to be carried through the pipe.

In use, such pipes may experience substantial changes in temperature, resulting in significant physical excursion over lengths of pipe (e.g. several hundred meters) due to thermal expansion and contraction. To prevent such excursions from damaging equipment (e.g. pumps, treatment facilities) connected to the pipes, anchors may be fixed to the pipe. The placement of the anchors is generally not known with sufficient accuracy to apply the anchors before assembly of the pipeline. To account for the unknown location requirements, anchors or anchor thrust rings are typically welded to the pipe after the pipeline is assembled. For polymer-lined pipes, this is not possible as any welding to the pipe will damage the polymer liner.

### SUMMARY

An aspect of the specification provides a system for anchoring a pipe relative to a ground-mounted support, comprising: a first clamp for engagement with the pipe at a first axial displacement from the support; and a second clamp for engagement with the pipe at a second axial displacement from the support, the second axial displacement having a direction opposite to the first axial displacement; each of the first clamp and the second clamp including: a primary member and a secondary member, removably fastenable together to encircle and apply a clamping force to the pipe; at least one of the primary member and the secondary member having a radially extending wall configured to engage the support for inhibiting axial movement of the pipe relative to the support.

### BRIEF DESCRIPTIONS OF THE DRAWINGS

Embodiments are described with reference to the following figures, in which:

FIG. 1 depicts an anchor system according to the prior art;

FIG. 2 depicts an anchor system according to a non-limiting embodiment;

FIG. 3 depicts a top view of the anchor system of FIG. 2;

FIG. 4 depicts an exploded view of a clamp in the anchor system of FIG. 2;

FIG. 5 depicts a front view of the anchor system of FIG. 2;

FIG. 6 depicts a partial cross-section of the anchor system of FIG. 2; and

FIG. 7 depicts a fastening assembly for the system of FIG. 2, according to another embodiment.

### DETAILED DESCRIPTION

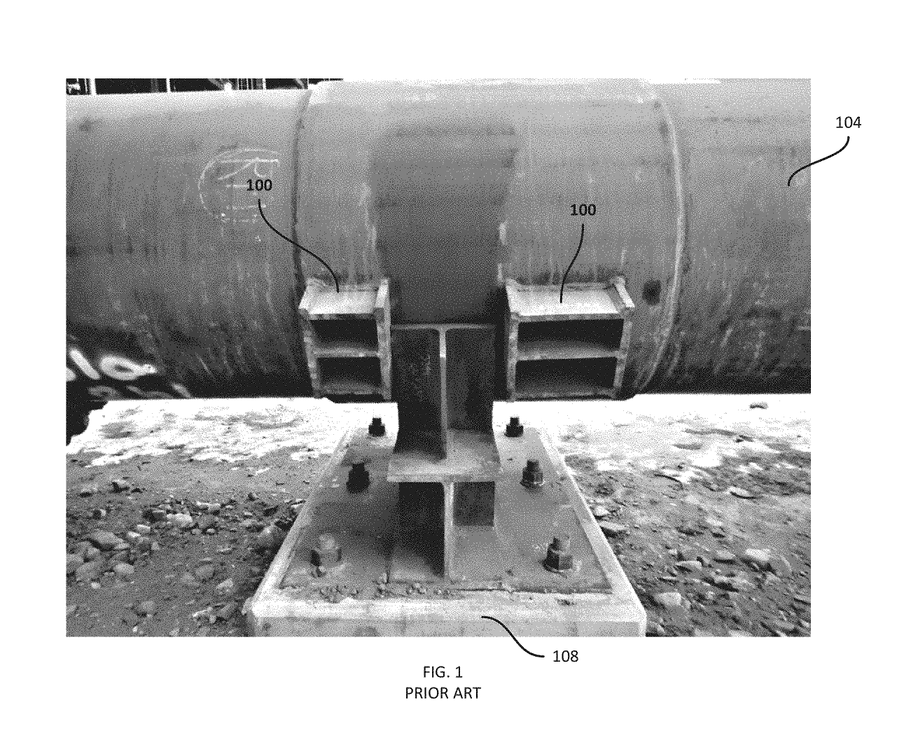

In conventional installations, anchor systems such as that shown in FIG. 1 may be employed. The anchor of FIG. 1 includes a pair of brackets 100 welded to the outside of a pipe 104, on either side of a ground-mounted support 108. The brackets 100 are welded to the pipe 104 after the pipe 104 is installed in the pipeline, since the exact position and width of the support 108 is typically not known with sufficient accuracy to pre-install the brackets 100. The brackets prevent longitudinal (i.e., axial) movement of the pipe 104, and are typically placed close to the attachment of the pipe 104 to end-point equipment (not shown). As a result, axial forces imposed on the end-point equipment by the pipe 104 due to thermal expansion and contraction are limited to those forces generated by thermal expansion and contraction of the length of pipe between the support 108 and the end-point equipment. By placing the support 108 close (e.g. about 10 meters) to the end-point equipment, such forces are reduced to a degree sufficient to avoid damage to the end-point equipment. The length of the pipe 104 extending away from the end-point equipment beyond the support 108 may be permitted to contract and expand freely.

Anchor systems such as those shown in FIG. 1, however, may not be suitable for polymer-lined pipes, as the process of welding the brackets 100 to the pipe 104 in the field may damage the polymer lining. Further, pre-fabricating brackets on the pipe 104 may be rendered difficult by unreliable field dimensions, which increase the risk of prefabricating the brackets in the wrong location on the pipe 104.

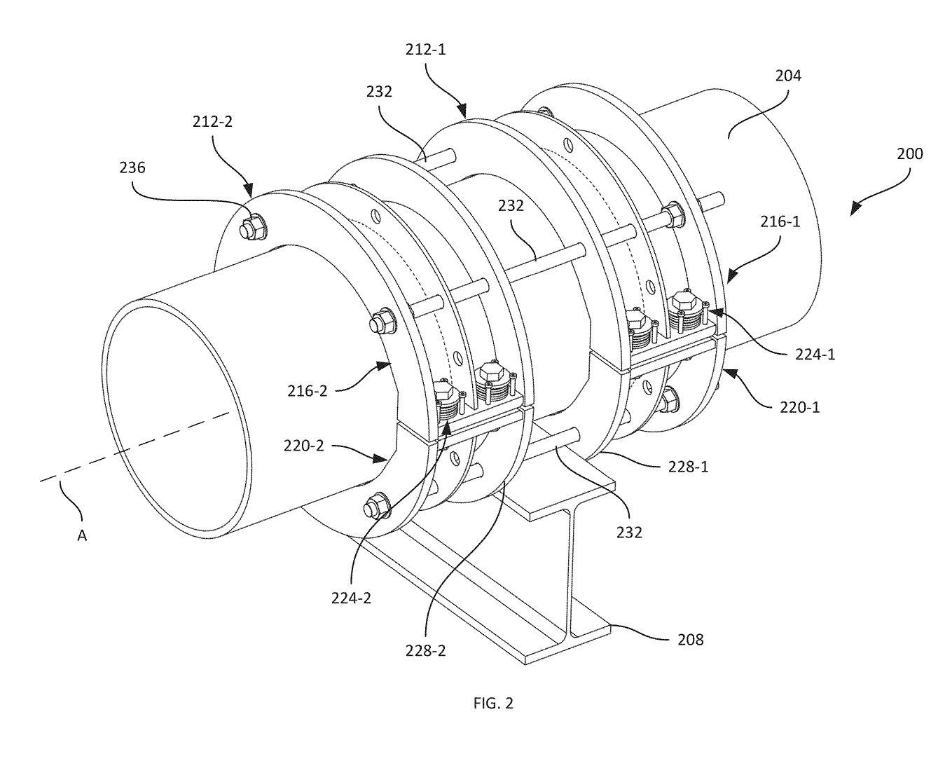

Turning to FIG. 2, a system 200 for anchoring a pipe 204 relative to a ground-mounted support 208 (e.g. an I-beam or any other suitable support structure) is illustrated. The system 200 includes a first weldment 212-1, also referred to as a first clamp 212-1, and a second weldment 212-2, also referred to as a second clamp 212-2. The clamps 212-1 and 212-2 are referred to collectively as the clamps 212 herein, or generically as a clamp 212. Similar nomenclature is employed for other components.

As will be discussed below, the clamps 212 are field-installable on the pipe 204 to encircle and apply a clamping force on the pipe 204. The clamps 212 are installed on opposite sides of the support 208. That is, as shown in FIG. 1, the first clamp 212-1 is placed at a first axial (i.e., relative to an axis A of the pipe 204) displacement relative to the ground support 208. The second clamp 212-2, meanwhile, is placed at a second axial displacement relative to the ground support 208, in a direction opposite to the first displacement. When the clamps 212 are placed on opposing sides of the support 108 and engaged with the pipe 204 to apply a clamping force thereto, the pipe 204 is anchored against axial movement relative to the support 108. In particular, the system 200 may therefore permit the isolation of equipment connected to a length of the pipe 204 on one side of the support 208 from axial forces induced by thermal expansion and contraction of the pipe 204.

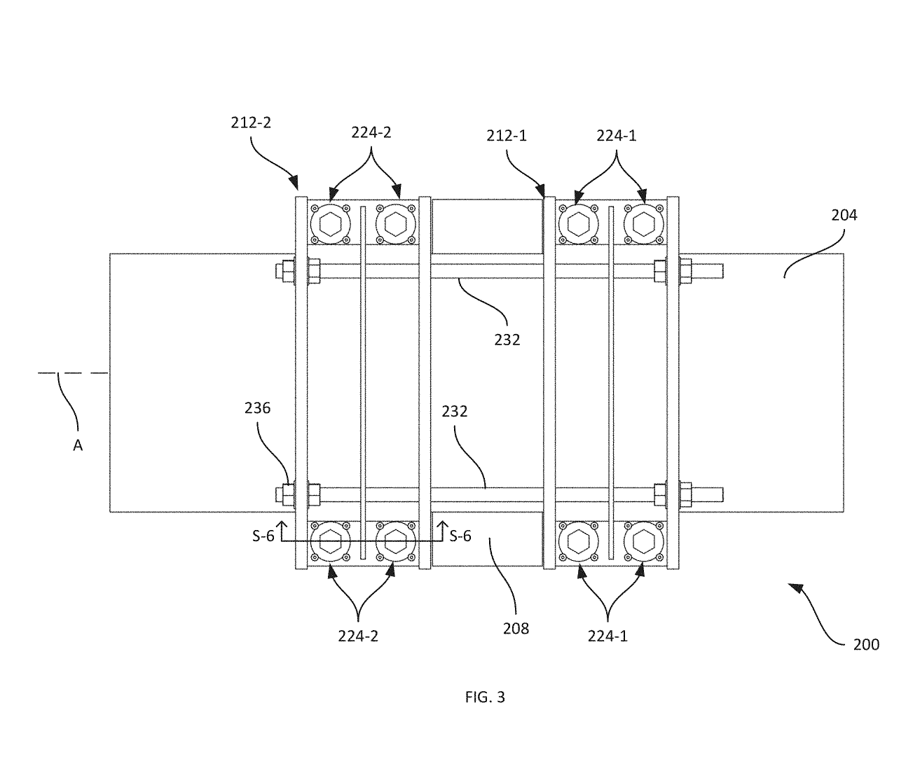

Each of the clamps 212 includes a primary member 216-1, 216-2 and a secondary member 220-1, 220-2. The members 216 and 220 of a given clamp 212 are removably fastenable together, as shown in FIG. 2, to encircle the pipe 204 and apply a clamping force thereto. In the present example, the members 216 and 220 are fastenable together by at least one fastening assembly. In the present example, each clamp 212 includes four fastening assemblies 224. Two assemblies 224-1 are shown in FIG. 2 for the clamp 212-1, as well as two assemblies 224-2 for the clamp 212-2. FIG. 3, which provides a top view of the system 200, illustrates all four assemblies 224. As seen in FIGS. 2 and 3, the fastening assemblies 224 are carried by primary members 216 in the present example. In other examples, some or all of the fastening assemblies 224 of a given clamp 212 may be carried instead by the secondary member 220.

As also shown in FIG. 2, the primary and secondary members 216 and 220 are arranged against a top and a bottom half, respectively, of the pipe 204. In other examples, the members 216 and 220 need not be placed in an upper and lower configuration as shown. For example, the members 216 and 220 may instead be placed against the sides of the pipe 204 (such that the seam between the members 216 and 220 is substantially vertical rather than substantially horizontal). Various other orientations may also be employed for the members 216 and 220.

Each of the clamps 212 also includes, on either or both of the primary and secondary members 216 and 220, a radially extending wall (i.e. extending substantially parallel with a radius of the pipe 204, or substantially perpendicular with the axis A) configured to engage the support 208 to inhibit axial movement of the pipe 204 relative to the support 208. In the illustrated example, such a wall is provided by a rib 228-1 extending radially from the secondary member 220-1. A further wall is provided by a rib 228-2 extending radially from the secondary member 220-2.

As seen in FIGS. 2 and 3, the clamps 212 can be connected together via one or more rods 232 (four are employed in the present example, three of which are visible in FIG. 2). The rods 232 may be fastened between the clamps 212 by any suitable fastener, such as nuts 236 and associated washers. As will now be apparent, additional clamps 212 can be placed on either or both sides of the support 208 at further axial displacements. The connection of a plurality of clamps 212 via the rods 232 permits the system 200 to be deployed to exert a greater clamping force on the pipe 204 (without necessarily increasing the clamping force exerted by each individual clamp 212).

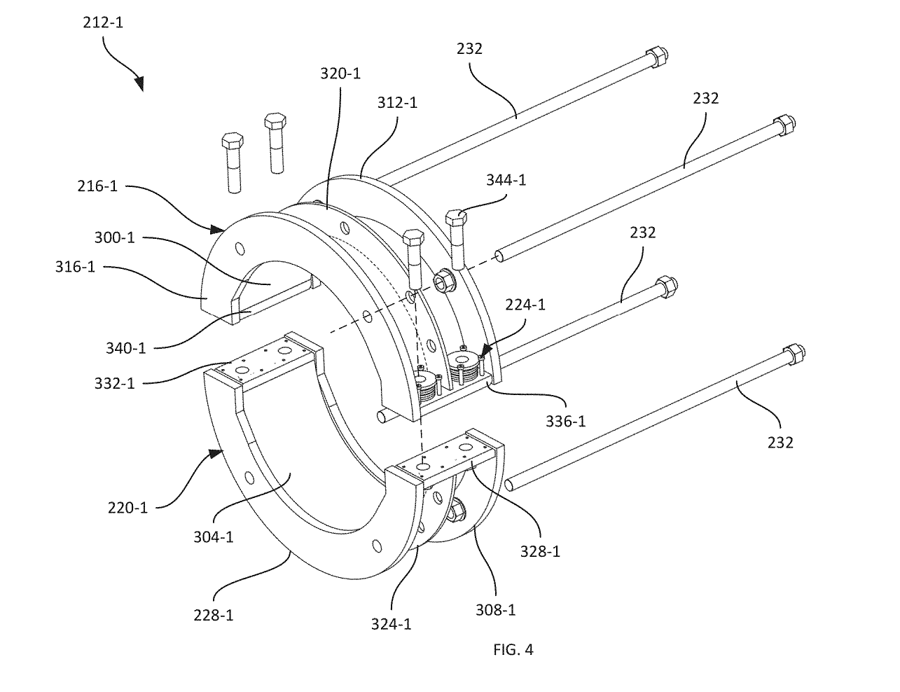

Turning now to FIG. 4, the components of a single clamp 212 are shown in greater detail. In particular, the clamp 212-1 is shown, although it is contemplated that the clamp 212-2 (and any other clamps 212 deployed in the system 200) can include the same components as discussed below.

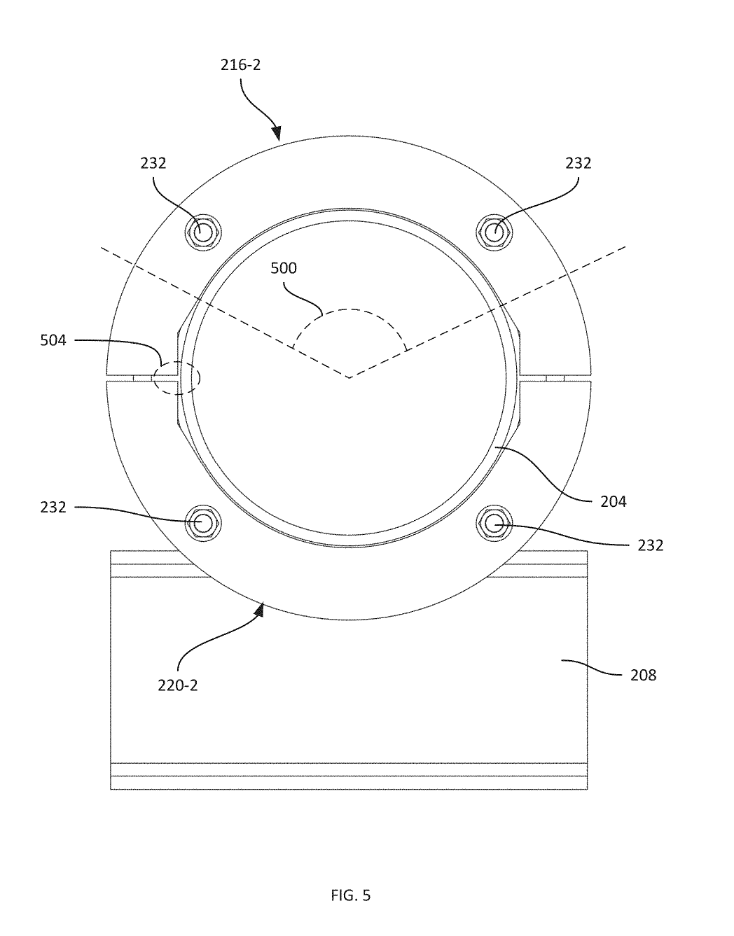

As noted earlier, the clamp 212-1 includes a pair of members 216-1 and 220-1, each of which includes a substantially c-shaped sleeve member 300-1, 304-1. As will now be apparent, when the members 216 and 220 are joined together, the sleeves 300 and 304 form a channel that substantially encircles the pipe 204. Referring briefly to FIG. 5, the sleeves 300 and 304 preferably contact an outer wall of the pipe 204 over an arc of at least ninety degrees. In the present example, the arc of contact between each sleeve 300, 304 and the pipe 204 extends over an angle 500 of about one hundred and thirty degrees. Further, as seen in FIG. 5, a space 504 may be left between the members 216 and 220 when the clamp 212 is assembled, for example to provide space for a weld seam (not shown) on the outer wall of the pipe 204.

Returning to FIG. 3, extending radially from the sleeves 300 and 304 is the previously mentioned rib 228-1, as well as ribs 308-1, 312-1 and 316-1. As illustrated, the ribs 228-1 and 308-1 extend from either longitudinal (i.e. in the direction of the axis A) end of the secondary member 220-1, while the ribs 312-1 and 316-1 extend from either longitudinal (i.e. in the direction of the axis A) end of the primary member 216-1. An additional, central rib 320-1 and 324-1 may also be included on each of the members 216-1 and 220-1, respectively (e.g. for structural reinforcement). Each of the ribs 228-1, 308-1, 312-1, 316-1, 320-1 and 324-1 can include apertures for receiving the rods 232 therethrough.

Each member 216-1 and 220-1 includes a flange extending radially from each side of the member 216-1, 220-1. In particular, flanges 328-1 and 332-1 are shown on opposite sides of the member 220-1, while flanges 336-1 and 340-1 are shown on opposite sides of the member 216-1. The above-mentioned flanges are configured to permit fastening of the members 216-1 and 220-1. Specifically, the flanges 336-1 and 340-1 each carry two fastening assemblies 224-1. Each fastening assembly includes a fastener, such as a bolt 344-1, configured for receipt through corresponding apertures in a pair of the flanges (e.g. in the flanges 336-1 and 328-1). As will be described in greater detail below, the fastening assemblies 224-1 can also include biasing mechanisms, such as one or more spring washers (also referred to as Belleville washers or Belleville discs) for control of the clamping force exerted on the pipe 204 by the clamp 212.

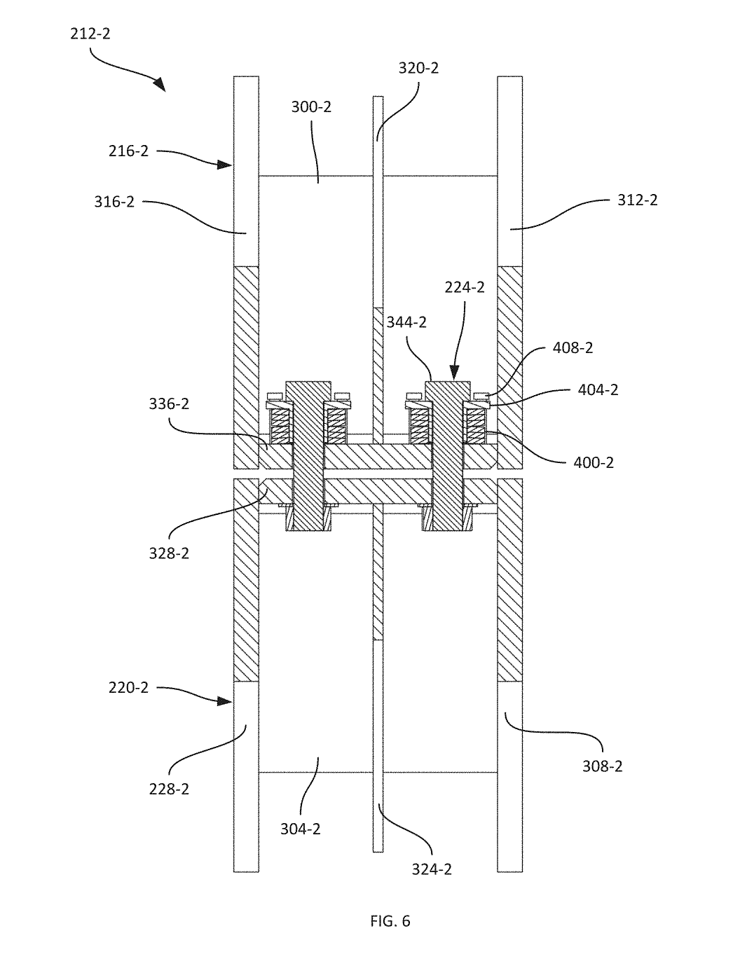

Turning to FIG. 6, a partial cross-section of the system 200, as indicated at S-6 in FIG. 3, is illustrated. In particular, the components of the clamp 212-2 are shown as numbered in connection with FIG. 4, but with the affix “−2” rather than “−1”. Thus, ribs 316-2, 320-2, 312-2, 228-2, 324-2 and 308-2 are shown, as are flanges 336-2 and 328-2 and two fastening assemblies 224-2.

Each fastening assembly 224, in the present example, includes the above-mentioned bolt 344-2, as well as a set of biasing elements 400-2, implemented as a stack of spring washers. The spring washers exert a preconfigured force against the bolt 344-2 and are compressible, thus permitting the aperture defined between the members 216-2 and 220-2 (that is, the space 504 shown in FIG. 5) to expand and contract to a predetermined degree in response to radial thermal expansion and contraction of the pipe 204. In addition to accommodating such radial thermal expansion and contraction, the spring washers allow the assembled members 216-2 and 220-2 to maintain a minimum clamping force on the pipe 204.

In particular, six spring washers are shown in the present example, in two opposing sets of three (that is, sets of three with opposing orientations). The assembly 224-2 also includes a retainer including a cap 404-2 and a plurality (four, in the present example, as seen in FIG. 3) of shoulder bolts 408-2 retaining the cap 404-2 against the relevant flange (336-2, in this example). The biasing elements 400-2 can therefore be pre-assembled and are maintained in place by the cap 404-2 awaiting installation of the clamp 212-2 on the pipe 204.

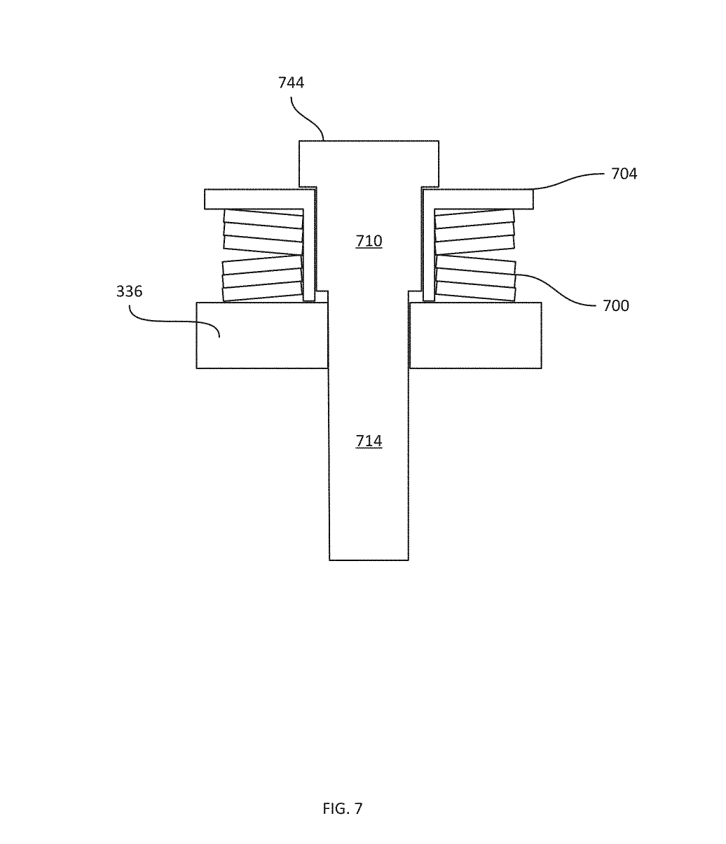

Turning to FIG. 7, an alternative fastening assembly is illustrated. The assembly includes a bolt 744, a set 700 of biasing elements, and a cap 704 as discussed above. However, the bolt 704 also includes a shoulder portion 710 having a greater diameter than a shaft 714 of the bolt 744. The shoulder portion 710 is configured to bottom out against the flange 336 when the elements 700 have been compressed to a predetermined degree, to prevent over-tightening of the bolt 744 during installation.

The scope of the claims should not be limited by the embodiments set forth in the above examples, but should be given the broadest interpretation consistent with the description as a whole.

1. A system for anchoring a pipe relative to a ground-mounted support, comprising:
a first clamp for engagement with the pipe at a first axial displacement from the support; and
a second clamp for engagement with the pipe at a second axial displacement from the support, the second axial displacement having a direction opposite to the first axial displacement;
each of the first clamp and the second clamp including:
a primary member and a secondary member, removably fastenable together to encircle and apply a clamping force to the pipe;
at least one of the primary member and the secondary member having a radially extending wall configured to engage the support for inhibiting axial movement of the pipe relative to the support.

2. The system of claim 1, wherein the primary member includes a substantially c-shaped sleeve include a fastening assembly on either side thereof; and
wherein the secondary member includes a further substantially c-shaped sleeve.

3. The system of claim 2, wherein the fastening assemblies are disposed on radially extending flanges on either side of the primary member.

4. The system of claim 2, wherein each fastening assembly includes a spring washer and a bolt configured to extend through the spring washer to engage the secondary member.

5. The system of claim 4, wherein the fastening assembly includes a retainer for the spring washer.

6. The system of claim 5, wherein the retainer includes a cap and a shoulder bolt for retaining the cap over the spring washer.

7. The system of claim 2, wherein each of the primary and secondary members include respective ribs extending radially from the sleeves of the primary and secondary members.

8. The system of claim 7, wherein each of the primary and secondary members includes a rib extending radially from each end thereof.

9. The system of claim 1, further comprising a rod connecting the first and second clamps.

10. The system of claim 9, wherein the rod extends through the respective walls of each of the first and second clamps.

11. The system of claim 10, further comprising a third clamp for engagement with the pipe at a third axial displacement from the support;
wherein the rod connects the third clamp to the first and second clamps.
